(19) United States
(12) Patent Application Publication
(10) Pub. No.: US 2024/0367980 A1
(43) Pub. Date: Nov. 7, 2024

(54) PRODUCTION OF CARBON- OR GRAPHITE-BASED ANODE ACTIVE MATERIALS FROM BIOMASS FEEDSTOCK

(71) Applicant: Honeycomb Battery Company, Dayton, OH (US)

(72) Inventors: Song-Hai Chai, Dayton, OH (US); Bor Z. Jang, Centerville, OH (US)

(73) Assignee: Honeycomb Battery Company, Dayton, OH (US)

(21) Appl. No.: 18/310,855

(22) Filed: May 2, 2023

(51) Int. Cl. C01B 32/205

(52) U.S. Cl. CPC C01B 32/205; C01P 2006/10

(57) ABSTRACT

A method of producing graphitic particles from a biomass, the method comprising: a) providing particles of a biomass and heat treating said biomass at a first temperature selected from a range of 100° C. to 1,500° C. for a first period of time to produce biochar particles and, optionally, mechanically reducing a size of the biochar particles to biochar particles having a size from 10 nm to 1 mm; b) mixing the biochar particles with a carbon precursor material and forming the resultant mixture into a plurality of secondary particles wherein a secondary particle comprise one or more than one biochar particle embedded in, encapsulated by, or coated with the carbon precursor; and c) heat-treating the secondary particles at a second temperature higher than the first temperature for a second period of time to produce the graphitic particles, wherein the second temperature is selected from 900° C. to 3,500° C.

### FIELD

The present invention relates to the art of anode active materials for lithium-ion or sodium-ion batteries and, in particular, to a method of producing graphite or hard carbon-based anode active materials from renewable sources.

### BACKGROUND

Concerns over the safety of earlier lithium secondary batteries led to the development of lithium-ion secondary batteries, in which a carbonaceous material is used as an anode active material. The carbonaceous material may comprise primarily graphite that can be intercalated with lithium and the resulting graphite intercalation compound may be expressed as LiₓC₆, where x is typically less than 1. In order to minimize the loss in energy density, x in LiₓC₆ should be maximized and the irreversible capacity loss Qᵢᵣ in the first charge of the battery should be minimized. Carbon anodes can have a long cycle life due to the presence of a protective solid-electrolyte interface layer (SEI), which results from the reaction between lithium and the electrolyte during the first several cycles of charge-discharge. The lithium in this reaction comes from some of the lithium ions originally released from the cathode and intended for the charge transfer purpose. As the SEI is formed, the lithium ions become part of the inert SEI layer and become irreversible, i.e., these lithium atoms can no longer be shuttled back and forth between the anode and the cathode. Therefore, it is desirable to use a minimum amount of lithium for the formation of an effective SEI layer. In addition to SEI formation, Qᵢᵣ has been attributed to graphite exfoliation caused by electrolyte solvent co-intercalation and other side reactions.

The maximum amount of lithium that can be reversibly intercalated into the interstices between graphene planes of a theoretically perfect graphite crystal is generally believed to occur in a graphite intercalation compound represented by LiₓC₆ (x=1), corresponding to a theoretical specific capacity of 372 mAh/g. In other “graphitized carbon materials” than pure graphite crystals, there exists a certain amount of amorphous or disordered carbon phase and a significant amount of graphite crystallites dispersed in the disordered phase. Each crystallite is typically composed of a number of graphene sheets (basal planes) that are stacked and bonded together by weak van der Waals forces along the crystallographic c-axis direction. The number of graphene sheets varies between just a few and several hundreds, giving rise to a c-directional dimension (thickness Lc) of typically a few nanometers to several hundreds of nanometers (nm). The length or width (La) of these crystallites is typically between tens of nanometers to microns.

The amorphous or disordered phase is a source of irreversible capacity loss since lithium stored in this phase tends to stay therein and does not come out during the subsequent discharge cycle, resulting in a significant drop of reversible capacity. Furthermore, an amorphous carbon phase tends to exhibit a low electrical conductivity (high charge transfer resistance) and, hence, a high polarization or internal power loss. Generally speaking, the amount of amorphous phase should be as small as possible in order to minimize the degree of irreversibility. The amorphous carbon phase is extensively present in carbon-based materials such as hard carbon (non-graphitizable carbon even when heat-treated at a temperature higher than 2,500° C.), soft carbon (graphitizable carbon), and meso-phase micro beads (MCMBs).

The graphitic or carbonaceous materials that can be converted into an anode material for a lithium-ion cell or sodium-ion cell include natural flake graphite, synthetic graphite, hard carbon, soft carbon, MCMBs, micron-scaled carbon or graphite fibers (typically having a diameter in the range of 6-12 μm), and vapor-grown carbon nano-fibers (VG-CNFs) having a diameter typically lower than 100 nm. Both natural and synthetic graphite materials typically have a wide variety of functional groups (e.g., carbonate, hydrogen, carboxyl, lactone, phenol, carbonyl, ether, pyrone, and chromene) at the edges of crystallites defined by La and Lc. These groups can react with lithium and/or electrolyte species to form a so-called in situ CB-SEI (chemically bonded solid-electrolyte interface) on which, for example, carboxylic acid surface films are converted into Li-carboxylic salts. In other words, this SEI layer consumes a certain amount of lithium during the first few charge/discharge cycles and, hence, is a source of irreversibility as well. On a more positive note, this SEI layer can protect natural graphite by preventing solvent-induced exfoliation of natural flake graphite.

Mining of natural graphite is generally considered as a highly polluting process due to the use of undesirable chemicals. Particles of synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon-based anode materials with scalable synthesis/fabrication processes from sustainable sources.

In this context, carbon anode materials from biomass resources are potential candidate anode active materials due to their ease in processing and handling, non-toxicity, and worldwide availability and abundance. However, biomass-derived carbon materials tend to contain highly porous internal structures after an initial heat treatment. Although a porous anode structure can be a desirable feature for use in a supercapacitor which demands a high specific surface area (m²/g), such a feature is typically viewed as undesirable when a porous carbon is used as a lithium-ion cell anode material. A high specific surface area, if not properly controlled, can lead to a high amount of SEI by consuming a large amount of lithium ions and liquid electrolytes during the first few charge-discharge cycles, resulting in a low first-cycle efficiency and short cycle life.

It is desired to have biomass-derived graphite or carbon materials that, when used as an anode active material of a lithium-ion battery or sodium-ion battery, exhibit excellent charge-discharge characteristics at both low and high charge/discharge rates.

It is further desired to have a method or process that is capable of cost-effectively producing such a carbon or graphite material at scale.

### SUMMARY

The present disclosure provides a simple, fast, scalable, environmentally benign, and cost-effective process or method that meets the afore-mentioned needs. The method of producing graphitic or carbonaceous particles from a biomass feedstock comprises: (A) providing a plurality of biochar particles (chips, granules, flakes, etc.), having a size from 10 nm to 10 mm (preferably less than 1 mm, more preferably less than 100 μm, further preferably less than 50 μm, and most preferably less than 10 μm), which are produced from a biomass feedstock via a first heat-treating step; (B) mixing the biochar particles with a carbon precursor material, having a carbon precursor-to-biochar weight ratio from 1/1000 to 100/1 (typically from 1/100 to 10/1 and more desirably from 1/50 to 1/1), and forming the resultant mixture into a plurality of secondary particles (also herein referred to as particulates) wherein a secondary particle comprises one or more than one biochar particle embedded in, encapsulated by, or coated with the carbon precursor; and (C) conducting a second heat-treating step that comprises heat-treating the plurality of secondary particles at a second temperature higher than the first temperature for a second period of time to produce the graphitic or carbonaceous particles, wherein the second temperature comprises a temperature selected from 900° C. to 3,500° C. (typically from 1,000° C. to 3,200° C. and more typically from 1,500° C. to 3,000° C.).

In certain embodiments, the biochar particles are produced by heat treating the biomass feedstock at a first temperature selected from a range of 100° C. to 1,500° C. for a first period of time to produce partially or fully carbonized biochar particles (herein referred to as the first heating step). Optionally (if the biochar particles are substantially larger than 1 mm, for instance), this procedure is followed by mechanically reducing the size of the biochar particles (e.g., crushing, grinding, granulating, milling, etc.) to an average size range approximately from 10 nm to 10 mm (preferably no greater than 1 mm, more preferably less than 100 μm, and further preferably less than 20 μm, and most preferably less than 10 μm).

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The biomass feedstock can be a mixture of a biomass with particles (chips, granules, flakes, etc.) of a recycled plastic.

In some embodiments, the carbon precursor is selected from petroleum heavy oil or pitch, coal tar pitch, a polynuclear hydrocarbon, a polymer, or a combination thereof. The polynuclear hydrocarbon may be selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

There is no theoretical restriction on the type of polymer that can be used as a carbon precursor, but preferably the polymer, when carbonized, has a carbon yield of greater than 10%, more preferably greater than 20%, and most preferably greater than 30%. The polymer as a carbon precursor may be selected from polyacrylonitrile (PAN), polyvinyl chloride (PVC), polyether ether ketone (PEEK), polysulfone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof. The carbon precursor can be selected from a recycled plastic.

In certain embodiments, the biomass feedstock prior to the first heat-treating step or the biochar prior to the second heat-treating step comprises particles of a recycled plastic.

In some embodiments, the biomass comprises an additive dispersed in the biomass during the first heat treating step or the biochar comprises an additive dispersed therein, wherein the additive is selected from a catalyst, a template, an activator or activation agent, a chemical functionalization agent, or a combination thereof, wherein the additive regulates a thermal transformation process of the biomass during the heat-treating step.

In some preferred embodiments, the catalyst comprises a transition metal selected from Ti, V, Cr, Mn, Fe, Co, Ni, Cu, Zn, Zr, Nb, Mo, Ru, Pd, Ag, Cd, Pt, Au, a combination thereof, or the catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.

The template may be selected from graphene oxide (GO), NaCl, and Ca-based salts. Catalysts, such as Fe-based (e.g., Fe(NO₃)₃, FeCl₃), Ni-based (e.g., NiCl₂, nickel nitrate), and Co-based (e.g., CoCl₂), may be added with a biomass to promote or facilitate organization or ordering of the aromatic domains.

The activation agent may be selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

Preferably, the biochar particles have a density from 0.01 to 2.0 g/cm³, after the first heat-treating step, and the graphitic or carbonaceous particles have a density from 1.4 to 2.26 g/cm³. With the presence of an activation agent mixed in the biomass feedstock during the first heat-treating step, the procedure involves carbonization and chemical activation, resulting in a biochar that is highly porous (density of 0.1 to 0.5 g/cm³), which is essentially an activated carbon (AC). The carbon precursor can partially or fully fill the pores of the AC particles and the final products (graphitic or carbonaceous particles) can be highly dense.

In some embodiments, the first heat treating step comprises a hydrothermal carbonization (HTC) at an HTC temperature selected from 100° C. to 600° C. for a first duration of time, and the second heat treating step comprises a pyrolysis procedure at a pyrolysis temperature higher than the selected HTC temperature for a second length of time. In some embodiments, a catalyst, a template, an activator, a chemical functionalization agent, or a combination thereof is present during the HTC and/or pyrolysis procedure.

The hydrothermal carbonization may comprise heat treating the biomass feedstock to induce decomposition of biomass molecules, polymerization, and/or aromatization at a desired first temperature and under a desired pressure for a first length of time for forming a mixture of graphene domains dispersed in a disordered matrix of carbon or hydrocarbon molecules, wherein the graphene domains are each composed of one or a plurality of planes of hexagonal carbon atoms or fused aromatic rings having a length or width from 5 nm to 10 μm. These graphene domains lead to a graphite structure during the second heat-treating step.

The biomass can contain lignocellulosic and/or non-lignocellulosic biomass. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc.

The nonlignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

In some preferred embodiments, the heat-treating procedure comprises (i) a hydrothermal carbonization (HTC) at an HTC temperature selected from 100° C. to 600° C. and (ii) a pyrolysis procedure at a pyrolysis temperature higher than the selected HTC temperature. The additive (a catalyst, a template, an activation agent, and/or a chemical functionalization agent) may be present during the HTC and/or the pyrolysis procedures.

The heat treatments serve to chemically transform the aromatic molecules (derived from biomass molecules) into “graphene domains” dispersed in or connected to a disordered matrix of carbon or hydrocarbon molecules. The matrix is characterized by having amorphous and defected areas of carbon or hydrocarbon molecules. These graphene domains can include individual single planes of hexagonally arranged carbon atoms (“graphene planes”) or multiple graphene planes (2-20 hexagonal carbon planes stacked together) that are embedded in or connected to disordered or defected areas of carbon or hydrocarbon molecules, which can contain other atoms (such as N, S, etc.) than C, O, and H.

In some embodiments, functionalizing agents contain a chemical functional group selected from alkyl or aryl silane, alkyl or aralkyl group, hydroxyl group, carboxyl group, amine group, sulfonate group (—SO₃H), aldehydic group, quinoidal, fluorocarbon, or a combination thereof.

In certain embodiments, the functionalizing agent contains an azide compound selected from the group consisting of 2-Azidoethanol, 3-Azidopropan-1-amine, 4-(2-Azidoethoxy)-4-oxobutanoic acid, 2-Azidoethyl-2-bromo-2-methylpropanoate, chlorocarbonate, azidocarbonate, dichlorocarbene, carbene, aryne, nitrene, (R—)-oxycarbonyl nitrenes, where R=any one of the following groups,

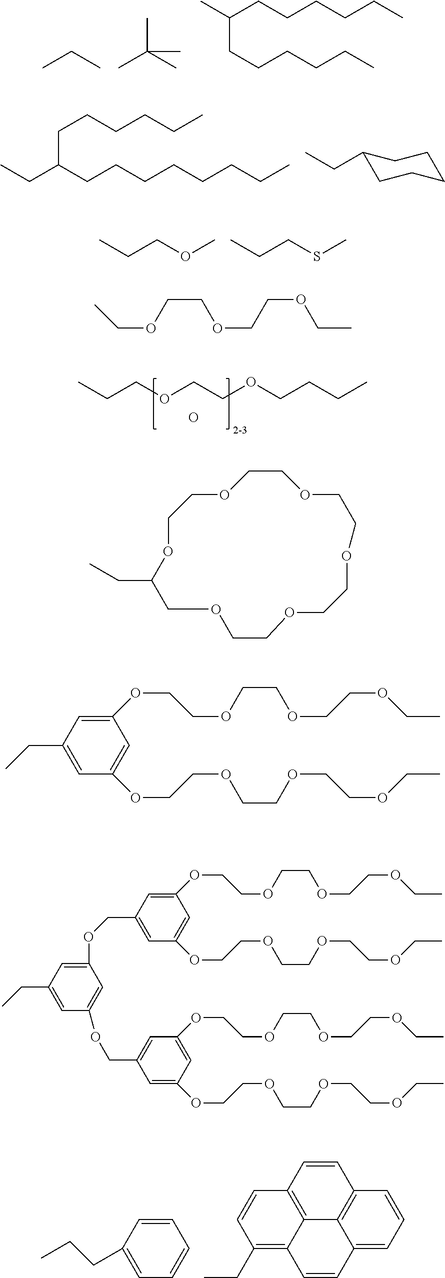

and combinations thereof.

In certain embodiments, the functionalizing agent contains an oxygenated group selected from the group consisting of hydroxyl, peroxide, ether, keto, and aldehyde. In certain embodiments, the functionalizing agent contains a functional group selected from the group consisting of SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

The functionalizing agent may contain a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof. The functionalizing agent may contain an acrylonitrile chain, polyfurfuryl alcohol, phenolic resin, or a combination thereof.

In some embodiments, the functionalizing agent contains a functional group selected from OY, NHY, O═C—OY, P═C—NR′Y, O═C—SY, O═C—Y, —CR′1-OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

### BRIEF DESCRIPTION OF THE DRAWINGS

FIG. 1(A) A flow chart showing the most commonly used prior art process of producing powder of hard carbon or graphite from a biomass feedstock.

FIG. 1(B) A flow chart showing the most commonly used prior art process of producing highly porous carbon or graphite from a biomass feedstock.

FIG. 2 A flow chart showing the presently invented process for producing graphite or carbon-based anode active materials for lithium-ion or sodium-ion cells from a biomass.

FIG. 3 A SEM image of biomass-derived activated carbon.

FIG. 4 A SEM image of biomass-derived, high temperature treated graphite powder containing irregular-shape particles.

FIG. 5 A SEM image of biomass-derived, high temperature treated graphite-based anode active material according to an embodiment of the present disclosure.

### DETAILED DESCRIPTION

Carbon materials can assume an essentially amorphous structure (glassy carbon), a highly organized crystal (graphite), or a wide range of intermediate structures that are characterized in that various proportions and sizes of graphite crystallites and defects are dispersed in an amorphous carbon matrix. Typically, a graphite crystallite is composed of multiple graphene planes (planes of hexagonal structured carbon atoms or basal planes) that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a natural graphite flake, artificial graphite bead, carbon/graphite fiber segment, carbon/graphite whisker, or carbon/graphite nano-fiber.

Mining and purification of natural graphite is generally considered as a highly polluting process due to the use of undesirable chemicals. Alternatively, synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon-based anode materials with scalable synthesis or fabrication processes primarily from sustainable sources with a minimal use of petroleum or coal source.

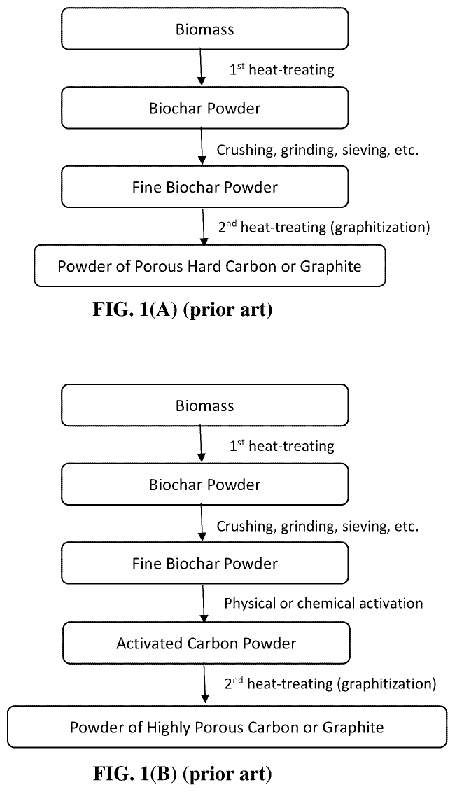

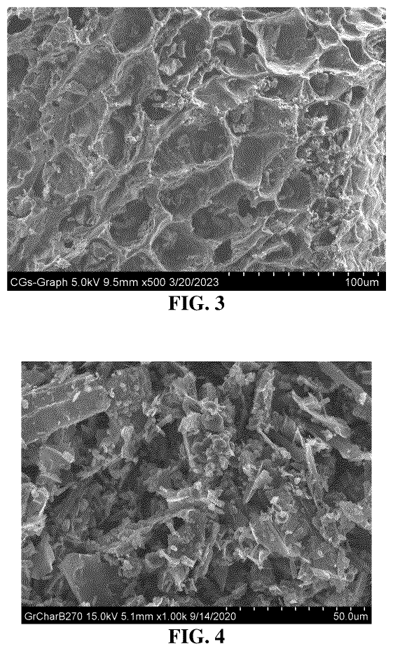

FIG. 1(A) and FIG. 1(B) illustrate the processes for producing biochar products, with or without a physical or chemical activation treatment. However, biomass-derived carbon materials tend to contain highly porous internal structures after an initial heat treatment (e.g., FIG. 3), with or without an activation procedure. Although a porous anode structure can be a desirable feature for use in a supercapacitor which requires a high specific surface area (m²/g), such a feature is typically viewed as undesirable when a porous carbon is used as a lithium-ion cell anode material. A high specific surface area, if not properly controlled, can lead to a high amount of SEI that consumes a large amount of lithium ions and liquid electrolytes during the first few charge-discharge cycles, resulting in a low first-cycle efficiency and short cycle life.

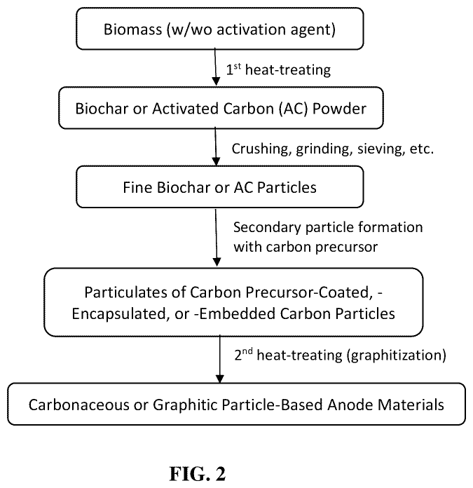

The present disclosure provides a simple, fast, scalable, environmentally benign, and cost-effective process or method of producing carbon or graphite-based anode active materials that meets the afore-mentioned needs. As schematically illustrated in FIG. 2, the method of producing graphitic or carbonaceous particles from a biomass feedstock comprises: (A) providing a plurality of biochar particles (chips, granules, flakes, pellets, etc.), having a size from 10 nm to 10 mm (preferably less than 1 mm, more preferably less than 100 μm, further preferably less than 50 μm, and most preferably less than 10 μm), which are produced from a biomass feedstock; (B) mixing the biochar particles with a carbon precursor material, having a carbon precursor-to-biochar weight ratio from 1/1000 to 100/1 (typically from 1/100 to 10/1 and more desirably from 1/50 to 1/1), and forming the resultant mixture into a plurality of secondary particles (also herein referred to as particulates) wherein a secondary particle comprises one or more than one biochar particle embedded in, encapsulated by, or coated with the carbon precursor; and (C) heat-treating said plurality of secondary particles at a second temperature higher than the first temperature for a second period of time to produce the graphitic or carbonaceous particles, wherein the second temperature comprises a temperature selected from 900° C. to 3,500° C. (typically from 1,000° C. to 3,200° C. and more typically from 1,500° C. to 3,000° C.).

In certain embodiments, the biochar particles are produced by heat treating the biomass feedstock at a first temperature selected from a range of 100° C. to 1,500° C. for a first period of time to produce partially or fully carbonized biochar particles; this step is herein referred to as the first heating step. Optionally (if the biochar particles are substantially larger than 1 mm, for instance), this procedure is followed by mechanically reducing the size of the biochar particles (e.g., crushing, grinding, granulating, milling, etc.) to an average size range from approximately 10 nm to 10 mm (preferably no greater than 1 mm, more preferably less than 100 μm, and further preferably less than 20 μm, and most preferably less than 10 μm).

The biomass feedstock may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The lignocellulosic biomass is the most abundant non-edible type of biomass from forestry and agricultural wastes, and consists of mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit. Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, etc. The non-lignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

As non-limiting examples, some of the biomass species that can be processed using the presently disclosed method are rice husk, recycled paper cup, hemp, shrimp or other types of soft shells, willow catkins, corn stalk, corn powder, corn cob, coconut shell, wheat straw, spruce bark, camphor leaves, banana peel, copinus comatus, nori, honey suckles, waste peanut shell, eggplant, wood chips, seaweed, soya bean, glucose, etc. This list is meant to illustrate the fact that a wide variety of sustainable products can be used and processed into graphene sheets. One can even convert agricultural and wood waste into highly valuable products.

In some embodiments, the carbon precursor is selected from petroleum heavy oil or pitch, coal tar pitch, a polynuclear hydrocarbon, a polymer, or a combination thereof. In most cases, one would need less than 20% by weight of the carbon precursor based on the total weight of carbon precursor and biochar combined. The polynuclear hydrocarbon may be selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

There is no theoretical restriction on the type of polymer that can be used as a carbon precursor, but preferably the polymer, when carbonized, has a carbon yield of greater than 10%, more preferably greater than 20%, and most preferably greater than 30%. The polymer as a carbon precursor may be selected from polyacrylonitrile (PAN), polyvinyl chloride (PVC), polyether ether ketone (PEEK), polysulfone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof.

In some embodiments, the biomass comprises an additive dispersed in the biomass for the first heat treating step or the biochar comprises an additive dispersed therein for the second heat treating step. The additive is selected from a catalyst, a template, an activator or activation agent, a chemical functionalization agent, or a combination thereof, wherein the additive regulates a thermal transformation process of the biomass during the heat-treating step or promotes graphitization of the biochar during the second heat treating step.

The template may be selected from graphene oxide (GO), NaCl, and Ca-based salts. Examples of activators are KOH and NH₄Cl. Examples of catalysts are Fe-based (e.g., Fe(NO₃)₃, FeCl₃), Ni-based (e.g., NiCl₂, nickel nitrate), and Co-based (e.g., CoCl₂), B. P, and various transition metals. The activation agent may be selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

Thus, in certain embodiments of the present disclosure, the catalyst comprises a transition metal selected from B, P, Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂. FeCl₃, FeBr₃, FeF₃, NiBr₂, NiI₂, Cs₂CO₃, CsF, CsCl, CsBr, CH₂Cl₂, or a combination thereof.

Typically, the biochar particles have a density from 0.01 to 2.0 g/cm³, after the first heat-treating step, and the graphitic or carbonaceous particles have a density from 1.4 to 2.26 g/cm³ after the second heat treatment. In some cases, with the presence of an activation agent mixed in the biomass feedstock during the first heat-treating step, the procedure involves concurrent carbonization and chemical activation, resulting in a biochar that is highly porous (density of 0.1 to 0.5 g/cm³), which is essentially an activated carbon (AC). Alternatively, AC can be produced by physical or chemical activation of biochar. The carbon precursor can partially or fully fill the pores of the AC particles and the final products (graphitic or carbonaceous particles) can be highly dense. This can significantly reduce the amount of solid-electrolyte interface (SEI) and thereby improving the first cycle efficiency and cycle life of a lithium-ion cell or sodium-ion cell.

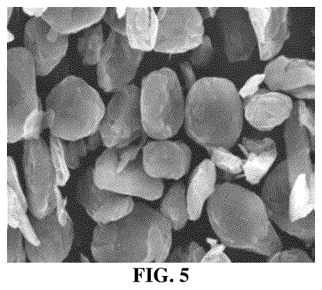

It is of interest to note that the biochar-derived graphitic or carbon powder using the prior art process (FIG. 1) tends to contain particles that are highly irregular in shape (e.g., FIG. 4) and particle sizes have a broad distribution, from very small particles to very large particles. These features make it difficult to produce anode electrodes in a consistent manner. The resulting electrodes also tend to have a relatively low packing density, leading to a lower energy density per unit volume of a battery cell. These issues are well addressed by the presently disclosed method of producing secondary particles of graphite from biochar/carbon precursor mixtures. The resulting particulates are relatively uniform in size and regular in shape (e.g., FIG. 5).

In some preferred embodiments, the heat-treating procedure comprises (i) a hydrothermal carbonization (HTC) at a HTC temperature selected from 100° C. to 500° C. (at a pressure of typically from 1.1-10 atm) for a first length of time, and (ii) a pyrolysis procedure at a pyrolysis temperature, higher than the selected HTC temperature, for a second length of time. The additive (a catalyst, a template, an activation agent, and/or a chemical functionalization agent) may be present during the HTC and/or the pyrolysis procedures. The chemical or mechanical means is operated during the HTC and/or pyrolysis.

In some embodiments, the invented method begins with heat-treating a biomass at a temperature selected from the range of 100° C. to 1,200° C., more preferably from 120° C. to 1,000° C., and further preferably from 150° C. to 1,000° C. In some preferred embodiments, the heat treatments include a first heat treatment temperature preferably in the range of 100° C. to 600° C. for a heat treatment time of preferably 0.2 to 24 hours (typically under a pressure of 1.1-10 atm). This is followed by a second heat treatment at a second temperature from 300° C. to 1,500° C. (more typically 600° C. to 1,000° C.) for preferably 0.2 to 24 hours.

At the first heat treatment temperature of 100° C. to 300° C., the biomass can get decomposed and undergo dehydrogenation polymerization that entails removal of non-carbon atoms, such as H and N, and lateral merging of fused aromatic rings to form longer and wider aromatic molecules (polyaromatic molecules) or more aromatic rings fused together in the length and width directions, much like growing polymer chains. The carbon precursor, typically being already highly aromatic or capable of forming fused ring structure, serves as a seed for promoting the formation and growth of more and larger graphene planes. Such a structure of fused aromatic rings can grow to contain up to 300 carbon atoms or approximately 100 rings fused together. Such a structure is an incipient graphene sheet.

At a second heat treatment temperature selected from 600° C. to 3,000° C., these incipient graphene sheets continue to grow in lateral dimensions (length and width) which can reach several micrometers and the resulting graphene sheets can each contain may thousands of fused rings. These dimensions and number of fused rings can be determined by using transmission electron microscopy (TEM) and atomic force microscopy (AFM).

By including a catalyst in the biomass feedstock (prior to the first heat-treating step) or in the biochar (prior to the second heat-treating), one can significantly accelerate the graphite formation process and reduce the required graphitization temperature.

Certain functional groups (chemical functionalization agents) may also promote merging between fused aromatic rings. For instance, the functional groups may be selected from SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate.

Other useful chemical functional groups or reactive molecules may be selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), hexamethylenetetramine, polyethylene polyamine, polyamine epoxy adduct, phenolic hardener, non-brominated curing agent, non-amine curatives, and combinations thereof. These functional groups are multi-functional, with the capability of reacting with at least two chemical species from at least two ends. Most importantly, they are capable of bonding to the edge or surface of graphene planes using one of their ends and, during subsequent epoxy curing stage, are able to react with epoxide or epoxy resin at one or two other ends.

The functional groups may be selected from OY, NHY, O═C—OY, P═C—NR′Y, O═C—SY, O═C—Y, —CR′1-OY, N′Y or C′Y, and Y is an appropriate functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₄O)_{w}H, (—C₂H₄O)_{w}—R′, (C₃H₆O)_{w}—R′, R′, and w is an integer greater than one and less than 200.

The following examples serve to provide the best modes of practice for the present invention and should not be construed as limiting the scope of the invention:

### Example 1: Production of Carbon/Graphite from Non-Lignocellulosic Biomass (e.g., Fruit)

Powder of graphitic materials was produced from heat treated fruit-based non-lignocellulosic biomass. The fruits of glossy privet were washed and dried at 80° C. for 6 h. Then, the fruits (22.328 g) were put into an autoclave (0.5 L) containing deionized water (200 mL) and H₃PO₄ (25 mL, as a chemical activation agent). The autoclave was subjected to a hydrothermal reaction at 195° C. for 24 h. A dark-brown solid was obtained by filtrating, washing with deionized water until reaching a neutral state, followed by drying at 70° C. for 3 h. This solid was basically a biochar, and also an activated carbon.

The solid biochar powder was ground homogeneously and then mixed with powder of recycled polyvinyl chloride (PVC) plastics at a biochar-to-plastic weight ratio of 2/1 through a solution mixing in acetone and then spray-drying to form secondary particles. Typically, the secondary particles each comprise multiple biochar particles embedded in or encapsulated by a PVC coating. A powder sample of these secondary particles were calcinated at 1,450° C. for 2 h in N₂ at a heating rate of 5° C./min to obtain graphitized particles. A sample of these graphite particles was mixed with SBR binder and water to form a slurry, which was coated onto a surface of a Cu foil to form an anode (negative electrode). This anode was tested in a half-cell configuration with a lithium metal foil as a counter electrode. The first cycle efficiency was found to be 94.3% and first cycle delithiation capacity was 322 mAh/g.

### Comparative Example 1: Without Secondary Particle Formation Via PVC Coating

For comparison, a sample was obtained under similar processing conditions, but without a secondary particle formation and carbon precursor coating procedure. The first cycle efficiency was found to be 88.6% and first cycle delithiation capacity was 281 mAh/g.

### Example 2: Graphite from Non-Lignocellulosic Biomass (e.g., Chitosan)

Chitosan is an abundant type of biomass (e.g., from shrimp shell). Chitosan may be converted into graphite with or without using a catalyst. In the present study, a two-step procedure was conducted, which included using FeCl₃ as a catalyst in a chitosan/FeCl₃ mixture and heat-treating the mixture. The residual Fe could be removed and recovered by acid washing.

In a typical process, chitosan and FeCl₃ were mixed in de-ionized (DI) water and dried at 80° C. to obtain a brown chitosan/FeCl₃ mixture. Then, the mixture was heated in a sealed furnace under Ar atmosphere at 400° C. for 2 hours to generate a powder mixture. After this first heat treatment procedure, the mixture was immersed in 1 M HCl for 1 hour to remove the Fe. The sample was dried overnight in a vacuum oven at 60° C. to form solid powder of a biochar. The biochar sample was divided into two portions. The first portion was mixed with an amount of petroleum pitch to form secondary particles. Both portions were then subjected to graphitization at 2,400° C. for 4 hours (the second heat treatment) to form anode active materials.

A sample of secondary particles was mixed with SBR binder (6% by weight) and water to form a slurry, which was coated onto a surface of a Cu foil to form an anode (negative electrode). Another sample of primary graphite particles (without mixing with pitch to form secondary particles) was also formed into an electrode in a similar manner. For both types of anode electrodes, electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The first cycle efficiency of the secondary particle-based graphite anode was found to be 94.6% and first cycle delithiation capacity was 341 mAh/g. In contrast, without going through the mixing and secondary particle formation, the first cycle efficiency was 83.7 and first cycle delithiation capacity was 266 mAh/g. The differences are quite significant.

### Example 3: Graphite Anode Materials from Lignocellulosic Biomass (e.g., Kraft Lignin)

The Kraft lignin with iron ions was prepared by the co-precipitation method. In a representative procedure, thirty (30) grams of Kraft lignin was first added to 30 mL tetrahydrofuran in a glass beaker and stirred for 2 h. Separately, 25 grams of iron (III) nitrate was added to 20 mL DI water in a smaller glass beaker and the mixture was stirred until dissolved completely. Subsequently, the iron nitrate solution was added drop-wise to the Kraft lignin solution and stirred for 2 h. The mixture was sealed in an autoclave and heated at 180° C. for 4 hours. The resulting partially reacted mixture was transferred to an oven where it was dried at 80° C. for 24 h.

Fifteen grams of the dried mixture was mixed with 5 grams of coal tar pitch in a mechanical mixer and then extruded out and pelletized to become secondary particles. These particles were packed in the middle of a 1-inch OD, stainless steel tubular reactor. The reactor was heated at a rate of 10° C./min to 1,500° C. and maintained at 1,500° C. for 1 h. Then, the furnace was cooled down at a rate of 10° C./min to room temperature. Another batch of sample was prepared in a similar manner, but the temperature was raised to 2,400° C. and maintained at this temperature for 2 hours.

### Example 4: Graphite Anode Materials from Lignocellulosic Biomass (e.g., Cellulose)

The precursor cellulose was prepared by mechanical milling. In a representative process, 50 g of bleached kraft pulp was loaded to a 500 ml PTFE pot containing zirconia balls of three size and numbers: 2 of 20 mm diameter, 100 of 10 mm diameter, and 300 of 6 mm diameter (631 g in total). Milling was conducted by a planetary ball mill at 300 rpm for 24 h. The obtained milled sample was used to prepare activated carbon with KOH swelling and intercalation, followed by high temperature activation. In an example, 2 g of milled cellulose was immersed in 100 ml of 10 wt % KOH and the resulting suspension was stirred at 5° C. for 2 h. Subsequently, the cellulose was filtrated and dried in an oven. The dried powder-like sample was calcined in a furnace at a temperature (600 and 700° C., respectively) for 1 h with a heating rate of 10° C./min under a nitrogen atmosphere. Upon cooling back to room temperature, the sample was immersed in a solution of 1 M HCl in deionized water, repeatedly rinsed with water, and then dried at 100° C. in an oven overnight. The product was activated carbon.

The activated carbon (AC) was mixed with petroleum pitch at an AC-to-pitch weight ratio of 4:1 and made into secondary particles via spray coating onto a glass substrate, which was dried and scratched off from the glass and processed in a food-processor. The secondary particles were further heat treated at 1, 500° C. for 2 hours.

### Example 5: Graphite Anode Materials from Mixed Lignocellulosic/Non-Lignocellulosic Biomass

Sugarcane bagasse pith was obtained by squeezing and extracting sugarcane juice from the sugarcane purchased from a supermarket. Then, the sugarcane bagasse pith (5 g) was suspended in 500 ml of distilled water containing 1 wt % glacial acetic acid dissolved therein. Chitosan (2.14 g) was then added into the acetic solution with continuous stirring until chitosan was completely dissolved. The resulting suspension was stirred for about 5 h at room temperature, and dried at 80° C. in an oven. The sugarcane bagasse pith/chitosan mixture was first heat-treated in an autoclave (180° C. at 2 atm pressure) for 1 hr. The resulting partially carbonized mass was then heated in a tube furnace for 1 h at 700° C. in Ar atmosphere with a ramp rate of 3° C./min to obtain a sample of biochar particles. A desired amount of recycled PAN fibers was dissolved in dimethylformamide (DMF) to form a solution. The biochar particles were then dispersed in this solution to form a slurry having a biochar-to-PAN weight ratio of 4:1. The slurry was spray-dried to form secondary particles, which were heat treated initially to 300° C., then 1,200° C., and then finally 2,550° C. for 2 hours to obtain graphite particles.

The presently disclosed method is simple, fast, cost-effective, and generally does not make use of undesirable chemicals. The starting materials are primarily biomass, which is considered a sustainable source.

1. A method of producing graphitic or carbonaceous particles from a biomass feedstock, said method comprising:
A) Providing a plurality of biochar particles, having a size from 10 nm to 10 mm, which are produced from a biomass feedstock through a first heat-treating step;
B) mixing the biochar particles with a carbon precursor material, having a carbon precursor-to-biochar weight ratio from 1/1000 to 100/1, and forming the resultant mixture into a plurality of secondary particles wherein a secondary particle comprises one or more than one biochar particle embedded in, encapsulated by, or coated with the carbon precursor; and
C) conducting a second heat-treating step that comprises heat-treating said plurality of secondary particles at a second temperature higher than the first temperature for a second period of time to produce the graphitic or carbonaceous particles, wherein the second temperature comprises a temperature selected from 900° C. to 3,500° C.

2. The method of claim 1, wherein said biochar particles are produced by the first heat-treating step that entails heat treating said biomass feedstock at a first temperature selected from a range of 100° C. to 1,500° C. for a first period of time to produce partially or fully carbonized biochar particles.

3. The method of claim 2, further including mechanically reducing a size of the biochar particles to an average size range from 10 nm to 10 mm.

4. The method of claim 1, wherein said biomass feedstock comprises a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof.

5. The method of claim 4, wherein said lignocellulosic biomass is selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methycellulose, sodium ligosulfonate, Kraft lignin, onion peels, camphor leaves, seaweed, wheat straw, or a combination thereof.

6. The method of claim 4, wherein said non-lignocellulosic biomass is selected from food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, or a combination thereof.

7. The method of claim 1, wherein said carbon precursor is selected from petroleum heavy oil or pitch, coal tar pitch, a polynuclear hydrocarbon, a polymer, or a combination thereof.

8. The method of claim 7, wherein said polynuclear hydrocarbon is selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

9. The method of claim 7, wherein said polymer is selected from polyacrylonitrile (PAN), polyvinyl chloride (PVC), polyether ether ketone (PEEK), polysulfone, polyimide, polyether imide, polyamide imide, polyphenylene sulfide (PPS), epoxy resin, phenolic resin or phenol formaldehyde, polyester, poly(furfuryl alcohol), carboxymethylcellulose, urea formaldehyde (UF), a mixture thereof, a copolymer thereof, an interpenetrating networks thereof, or a combination thereof.

10. The method of claim 2, wherein said biomass comprises an additive dispersed in said biomass during said first heat treating step or in said biochar during the second heat-treating step, wherein said additive is selected from a catalyst, a template, an activator or activation agent, a chemical functionalization agent, or a combination thereof.

11. The method of claim 10, wherein said activation agent is selected from ZnCl₂, NaOH, KOH, K₂CO₃, NH₄Cl, phosphoric acid (H₃PO₄), hydrochloric acid, sulfuric acid, sulfonic acid, nitric acid, and a combination thereof.

12. The method of claim 1, wherein the biochar particles have a density from 0.1 to 2.0 g/cm³ and the graphitic or carbonaceous particles have a density from 1.4 to 2.26 g/cm³.

13. The method of claim 2, wherein said first heat treating comprises a hydrothermal carbonization (HTC) at an HTC temperature selected from 100° C. to 600° C. for a first duration of time, and the second heat treating step comprises a pyrolysis procedure at a pyrolysis temperature higher than the selected HTC temperature for a second length of time.

14. The method of claim 13, wherein a catalyst, a template, an activator, a chemical functionalization agent, or a combination thereof is present during the HTC and/or pyrolysis procedure.

15. The method of claim 13, wherein said hydrothermal carbonization comprises heat treating said biomass feedstock to induce decomposition of biomass molecules, polymerization, and/or aromatization at a desired first temperature and under a desired pressure for a first length of time for forming a mixture of graphene domains dispersed in a disordered matrix of carbon or hydrocarbon molecules, wherein said graphene domains are each composed of one or a plurality of planes of hexagonal carbon atoms or fused aromatic rings having a length or width from 5 nm to 10 μm.

16. The method of claim 10, wherein said chemical functionalizing agent contains a chemical functional group selected from alkyl or aryl silane, alkyl or aralkyl group, hydroxyl group, carboxyl group, amine group, sulfonate group (—SO₃H), aldehydic group, quinoidal, fluorocarbon, or a combination thereof.

17. The method of claim 10, wherein said chemical functionalizing agent contains an oxygenated group selected from the group consisting of hydroxyl, peroxide, ether, keto, and aldehyde.

18. The method of claim 10, wherein said chemical functionalizing agent contains a functional group selected from the group consisting of SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

19. The method of claim 10, wherein said cemical functionalizing agent contains a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

20. The method of claim 10, wherein said functionalizing agent contains an acrylonitrile chain, polyfurfuryl alcohol, phenolic resin, or a combination thereof.

21. The method of claim 10, wherein said catalyst comprises B, P, a transition metal selected from Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂Cl₂, or a combination thereof.

22. The method of claim 1, wherein said biomass feedstock prior to the first heat-treating step or the biochar prior to the second heat-treating step comprises particles of a recycled plastic.
